(19) United States
(12) Patent Application Publication
(10) Pub. No.: US 2009/0011287 A1
(43) Pub. Date: Jan. 8, 2009

(54) High temperature fuel cell stack and fuel cell having the same

(76) Inventors: Sung-Chul Lee, Suwon-si (KR); Ju-Yong Kim, Suwon-si (KR); Jin-Goo Ahn, Suwon-si (KR); Min-Jung Oh, Suwon-si (KR); Joseph Jeong, Suwon-si (KR); Jae-Woong Choi, Suwon-si (KR); Woong-Ho Cho, Suwon-si (KR); Dong-Uk Lee, Suwon-si (KR)

Correspondence Address: ROBERT E. BUSHNELL, 1522 K STREET NW, SUITE 300, WASHINGTON, DC, 20005-1202, US

(21) Appl. No.: 11/905,969

(22) Filed: Oct. 5, 2007

(30) Foreign Application Priority Data
Nov. 14, 2006 (KR) 10-2006-0112222

(51) Int. Cl. H01M 8/00; H01M 8/04

(52) U.S. Cl. 429/13; 429/26

(57) ABSTRACT

In a fuel cell, a fuel cell stack for high temperature comprises: a main body of the fuel cell having an electrolyte membrane, and an anode electrode and a cathode electrode bonded to both sides of the electrolyte membrane for generating electric energy by electro-chemically reacting fuel supplied to the anode electrode and oxidizer supplied to the cathode electrode; and a heater having a chamber attached to the main body of the fuel cell and an oxidation catalyst installed inside the chamber. The heater generates heat by oxidizing fuel supplied to the inside of the chamber, and heats the main body of the fuel cell with the generated heat. According to the present invention, it is possible to significantly reduce the starting time of the main body of the fuel cell, and to easily control a starting temperature of the main body of the fuel cell.

### CLAIM OF PRIORITY

This application makes reference to, incorporates the same herein, and claims all benefits accruing under 35 U.S.C.§119 from an application for HIGH TEMPERATURE FUEL CELL STACK AND FUEL CELL HAVING THE SAME earlier filed in the Korean Intellectual Property Office on the 14 Nov. 2006 and there duly assigned Serial No. 2006-0112222.

### BACKGROUND OF THE INVENTION

1. Field of the Invention

The present invention relates to a fuel cell stack and a fuel cell adopting a fuel cell stack.

2. Description of the Related Art

A fuel cell is a power generation system which directly converts fuel energy into electric energy, wherein the fuel cell has the advantages of low pollution and high efficiency. In particular, the fuel cell uses energy sources such as petroleum energy, natural gas, and methanol, etc., which are easy to store and transport, in order to generate electric energy, so that it has been spotlighted as the next generation of energy source. Such fuel cells are divided into a phosphoric acid fuel cell, a molten carbonate fuel cell, a solid oxide fuel cell, a polymer electrolyte fuel cell and an alkaline fuel cell, etc. according to the type of electrolyte used. These fuel cells are basically operated based on the same principle, but they are different in the type of fuel used, driving temperature, catalyst and electrolyte, etc.

The polymer electrolyte membrane fuel cell is a fuel cell using a polymer membrane having hydrogen protons exchanging characteristics as an electrolyte, and it has the advantages of high output characteristics with high current density, a simple structure, rapid starting and answering characteristics, and excellent durability over other fuel cells. In addition, it can use, as a fuel, methanol or natural gas in addition to hydrogen so that it can be widely applied to various fields, for example, as a power source for an automobile, a distributed on-site generator, an emergency power source for the military, a power source for a spaceship, etc.

The direct methanol fuel cell (DMFC) uses a polymer membrane conducting hydrogen protons as an electrolyte, and has a structure which is capable of directly supplying liquid methanol aqueous solution as a fuel to an anode. The DMFC is operated at a temperature less than 100° C. without using fuel reformer so that it is suitable for a portable or a small-sized fuel cell structure.

The polymer electrolyte membrane fuel cell or the direct methanol fuel cell can be manufactured with a stack structure wherein a plurality of single cells are structurally stacked or electrically connected. However, the fuel cell stack used in the above described fuel cell is controlled so as to operate in a predetermined temperature range in order to obtain a desired performance. In particular, the fuel cell stack is generally controlled to commence the generation of electricity above a predetermined temperature when starting. In other words, the fuel cell stack has a reaction temperature which is determined by ion conductivity and thermal stability of a polymer membrane used as an electrolyte. Therefore, the fuel cell stack has an operating temperature range above a predetermined temperature in order to make its operation stable. In particular, a high temperature fuel cell stack using acid doped polybenzimidazole as an electrolyte has an operating temperature range of about 150 to 200° C.

For this reason, the fuel cell stack requires a predetermined time in order to preheat the stack at an operating temperature when starting. Accordingly, current technology has adopted a method using the heat of an electric heater, a method using the exhaust gas of a heat source or a combination thereof, etc. in order to preheat the fuel cell stack. However, since the method using the electric heater requires much electric energy, for example, about 150 W, it has a disadvantage in that it needs a large capacity power supply. A method using the exhaust gas of a heat source used in the reformer has disadvantages in that the structure is complicated due to the installation of a separate tube and the starting time is long, for example, more than 30 minutes. In addition, the method using both the electric heater and the heat source of the reformer can slightly reduce the electric energy consumed as compared to the method using only the electric heater, and it can slightly reduce the starting time as compared to the method using only the heat source of the reformer. However, it has a disadvantage in that the electric energy consumed is still enormous and the starting time is long.

### SUMMARY OF THE INVENTION

It is an object of the present invention to provide a new structural fuel cell stack capable of significantly reducing energy consumed in preheating the fuel cell stack when the fuel cell stack is started, and significantly reducing the starting time thereof.

It is another object of the present invention to provide a fuel cell capable of reducing energy consumed in preheating a system by adopting the fuel cell stack and reducing starting time in order to improve convenience of use.

In order to accomplish the objects, according to one aspect of the present invention, there is provided a fuel cell stack including: a main body of a fuel cell having an electrolyte membrane, and an anode electrode and a cathode electrode bonded to both sides of the electrolyte membrane, for generating electric energy by electrochemical reaction between fuel supplied to the anode electrode and oxidizer supplied to the cathode electrode; and a heater for generating heat by oxidizing fuel supplied to the interior of a chamber, and for heating the main body of the fuel cell with the generated heat.

According to another aspect of the present invention, there is provided a fuel cell including: a main body of a fuel cell having an electrolyte membrane, and an anode electrode and a cathode electrode bonded to both sides of the electrolyte membrane, for generating electric energy by electrochemical reaction between fuel supplied to the anode electrode and oxidizer supplied to the cathode electrode; a heater having a chamber attached to at least one side of the main body of the fuel cell and an oxidation catalyst installed inside the chamber, wherein the heater generates heat by oxidizing fuel supplied to the interior of the chamber when the main body of the fuel cell is started and heats the main body of the fuel cell with the generated heat; and a fuel supplier for supplying fuel to the main body of the fuel cell and the heater. Herein, the main body of the fuel cell and the heater are included in the fuel cell stack.

Preferably, the fuel cell stack further includes a heat conductive adhesion means for attaching the heater to the outside of the main body of the fuel cell.

The chamber and the main body of the fuel cell include a relief structure located at a portion so that they contact each other.

The fuel cell stack further includes a supporting member for closely adhering the chamber and the main body of the fuel cell.

The heater includes two heaters installed on at least both opposing sides of the main body of the fuel cell.

The fuel cell stack further includes an oxidizer supplier for supplying oxidizer to the heater.

The temperature of the main body of the fuel cell is controlled according to the allocation ratio of the fuel and the oxidizer supplied to the main body of the fuel cell.

According to a further aspect of the present invention, there is provided a fuel cell operating method for supplying heat to a main body of a fuel cell for rapidly preheating the main body of the fuel cell having an electrolyte membrane and an anode electrode and a cathode electrode bonded to both sides of the electrolyte membrane, the method comprising the steps of: supplying fuel and oxidizer to a chamber attached to the main body of the fuel cell and a heater having an oxidization catalyst installed inside the chamber; and heating the main body of the fuel cell up to a desired temperature with heat generated from the heater.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic view of a fuel cell stack according to a first embodiment of the present invention;

FIG. 2 is a schematic view of a fuel cell stack according to a second embodiment of the present invention;

FIG. 3 is a schematic view of a fuel cell stack according to a third embodiment of the present invention;

FIG. 4 is a schematic view of a fuel cell stack according to a fourth embodiment of the present invention;

FIG. 5 is a schematic view of a fuel cell stack according to a fifth embodiment of the present invention;

FIG. 6 is a schematically exploded perspective view of a main body of a fuel cell adoptable in an embodiment of the present invention;

FIG. 7 is a schematic view of a fuel cell using a fuel cell stack according to an embodiment of the present invention.

### DETAILED DESCRIPTION OF THE INVENTION

Hereinafter, preferable embodiments which can be easily carried out by those skilled in the art to which the present invention belongs will be described with reference to the accompanying drawings.

In the detailed description below, a fuel cell stack of the present invention includes a general fuel cell stack to which a heater is attached. Accordingly, in order to distinguish the fuel cell stack of the present invention from an existing general fuel cell stack, the existing fuel cell stack is referred to as the main body of the fuel cell.

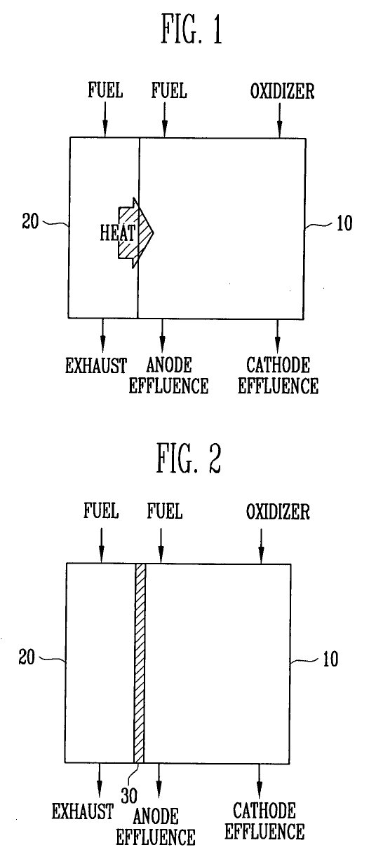

FIG. 1 is a schematic view of a fuel cell stack according to a first embodiment of the present invention.

Referring to FIG. 1, the fuel cell stack of the present invention is coupled to a main body 10 of a fuel cell and specifically to one side of the main body 10 of the fuel cell, and includes a heater 20 for generating heat by oxidizing fuel when starting and for heating the main body 10 of the fuel cell with the generated heat.

The main body 10 of the fuel cell is constituted by a polymer membrane, a single cell configured as an anode electrode and a cathode electrode bonded to both sides of the polymer membrane, and a separator allowing a plurality of single cells to make up a stack. In particular, attaching the anode electrode and the cathode electrode to the polymer membrane using a hot pressing method, etc. is referred to as membrane-electrode assembly (MEA). The main body 10 of the fuel cell can be constituted by stacking several tens and several hundreds of single cells in which fuel supplied to the anode electrode and oxidizer supplied to the cathode electrode are electro-chemically reacted. In addition, the main body 10 of the fuel cell is constituted by pressing both end plates thereof with a fixed member or air pressure in order to reduce contact resistance between components. A connector for outputting an outlet and an inlet of reaction gas, a cooling water circulating hole, and a connector for outputting power may be installed on both end plates.

The heater 20 is attached to one side of the main body 10 of the fuel cell and heats the main body 10 of the fuel cell with heat generated by combusting fuel flowing in from the outside through an oxidization catalyst reaction. The heater 20 includes an outlet for exhausting byproducts generated by the oxidization catalyst reaction.

The operating principle of the fuel cell stack according to the present invention will be described as follows. When starting the fuel cell stack, if the fuel and the oxidizer are supplied to the main body 10 of the fuel cell and the fuel is supplied to the heater 20, the heater 20 generates heat by combusting the fuel flowing in through the oxidation catalyst reaction in order to rapidly raise the temperature of the main body 10 of the fuel cell to the operating temperature and heats the main body 10 of the fuel cell with the generated heat. Since the heater 20 is attached to the outside surface of the main body 10 of the fuel cell, the heat generated by the heater 20 can be rapidly transferred to the main body 10 of the fuel cell in the form of conduction heat and radiant heat. Next, the main body 10 of the fuel cell is normally operated at an operating temperature, exhausts byproducts by an electro-chemical reaction on the anode side as anode effluent, and exhausts byproducts by an electrochemical reaction on the cathode side as a cathode effluent. According to the present invention, it is possible to rapidly preheat the fuel cell stack.

FIG. 2 is a schematic view of a fuel cell stack according to a second embodiment of the present invention.

Referring to FIG. 2, the fuel cell stack of the present invention includes a main body 10 of a fuel cell, a heater 20, and an adhesion means 30 disposed between opposing sides of the main body 10 of the fuel cell and the heater 20.

The fuel cell stack according to the present embodiment uses the adhesion means 30 to attach the heater 20 to the fuel cell stack 10.

For example, a thermal conductive tape and a thermal conductive adhesive, etc., which are members capable of effectively transferring heat from the heater 20 to the main body 10 of the fuel cell, can be used as the adhesion means 30.

FIG. 3 is a schematic view of a fuel cell stack according to a third embodiment of the present invention.

Referring to FIG. 3, the fuel cell stack of the present invention includes a main body 10 of a fuel cell, two heaters 20 attached to both opposite sides of the main body 10 of the fuel cell, and a supporting member 32 for closely adhering and fixing the two heaters 20 to the main body 10 of the fuel cell.

In the fuel cell stack according to the present embodiment, the two heaters 20 attached to both opposite sides of the fuel cell stack 10 are closely adhered and fixed to the main body 10 of the fuel cell by the supporting member 32.

As the supporting member 32, a clamp, a band, or the like (such as an iron clamp or a clamp screw) can be used as a means capable of closely adhering and fixing the heater 20 to the outside surface of the main body 10 of the fuel cell.

Of course, the fuel cell stack of the present invention can be implemented by using all of the adhesion means and the supporting member as described above.

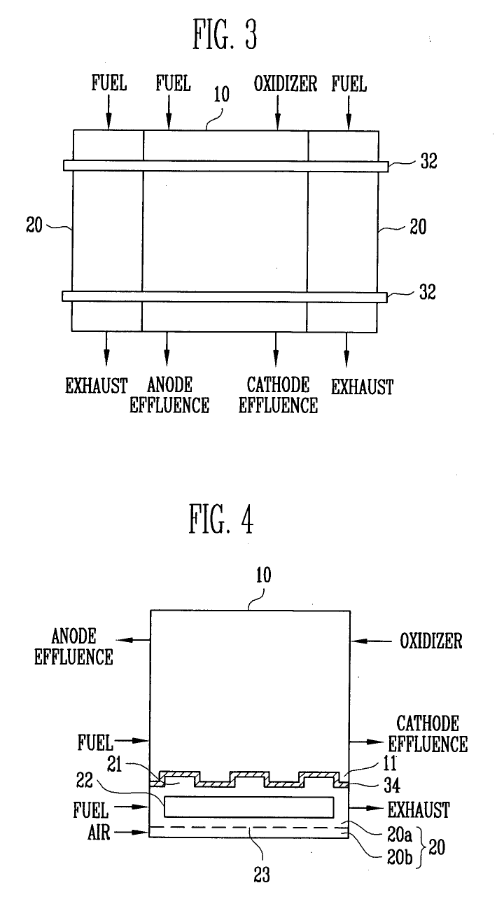

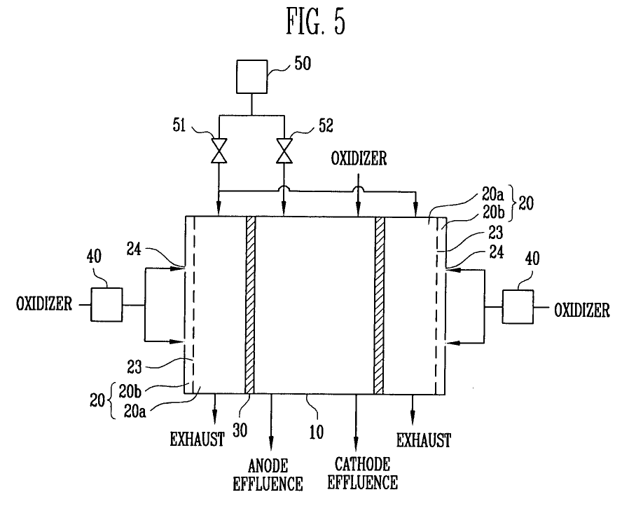

FIG. 4 is a schematic view of a fuel cell stack according to a fourth embodiment of the present invention.

Referring to FIG. 4, the fuel cell stack of the present invention includes a main body 10 of a fuel cell, a heater 20, and a thermal conductive pad 34 inserted between the opposing sides of the fuel cell 10 and the heater 20.

The heater 20 includes a combustor 20a having an oxidation catalyst 22 installed inside the chamber and a distributor 20b having a plurality of holes 23 for distributing and supplying air Ito the whole region of the combustor 20a in order to effectively supply air to the combustor 20a. As the oxidation catalyst 22, a catalyst selected from a group consisting of at least one of PdAl₂O₃, NiO, CuO, CeO₂, Al₂O₃ or Pu, Pd, Pt, methane as main components can be used.

The fuel cell stack according to the present embodiment has a shape such that a relief part 11 installed on one side of the main body 10 of the fuel cell is fixed into a relief part 21 installed on one side of the heater 20, and includes a thermal conductive pad 34 inserted between the relief parts 11 and 21, such that a thermal conductive area of heat transferred from the heater 20 to the main body 10 of the fuel cell is increased by the relief parts 11 and 21, thereby making it possible to more effectively conduct and radiate heat generated by the heater 20 to the main body 10 of the fuel cell.

The thermal conductive pad 34 prevents thermal flow transferred from the heater 20 to the main body 10 of the fuel cell from being intercepted by removing a small and fine air gap between the relief part 11 of the main body 10 of the fuel cell and the relief part 21 of the heater 20. In other words, the thermal conductive pad 34 does not allow a gap between the relief parts 11 and 21 to be generated when coupling the relief parts 11 and 21, and the thermal conductive pad 34 is filled between the relief parts 11 and 21. A thermal pad, such as T-gon product from Laird Technologies Co. or a silicon pad, or the like, which can effectively transfer heat generated electrically and electronically in a state of liquid or a rubber plate, may be used for the thermal conductive pad 34.

Of course, in the fuel cell stack of the present invention, the thermal conductive pad 34 can be replaced with a conductive tape or thermal conductive adhesives, and the coupling of the main body 10 of the fuel cell and the heater 20 can additionally be fixed and supported by a supporting member.

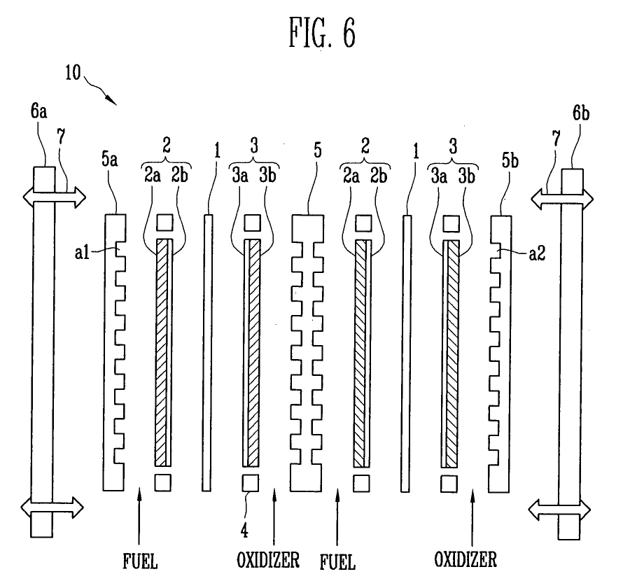

FIG. 5 is a schematic view of a fuel cell stack according to a fifth embodiment of the present invention.

Referring to FIG. 5, the fuel cell stack of the present invention includes a main body 10 of a fuel cell, two heaters 20 each attached to the opposing two outside surfaces of the main body 10 of the fuel cell, an adhesion means 30 for bonding the main body 10 of the fuel cell and the heater 20, an oxidizer supplier 40 for supplying oxidizer to the two heaters 20, and a fuel supplier 50 for supplying fuel to the main body 10 of the fuel cell and the heater 20.

The heater 20 includes a combustor 20a having a chamber and an oxidation catalyst installed inside the chamber and a distributor 20b separated from the inside of the chamber and distributing and supplying oxidizer to the whole region of the combustor 20a through a plurality of holes 23. In particular, the heater 20 according to the present embodiment is supplied with the oxidizer from the oxidizer supplier 40 (disposed outside the distributor 20b) through two supply holes 24 installed on another side facing one side of the heater 20 attached to the main body 10 of the fuel cell.

The oxidizer supplier 40 supplying oxidizer to the two heaters 20 coupled to both opposing sides of the main body 10 of the fuel cell can be implemented by a single apparatus or by two separate apparatuses. Also, the oxidizer supplier 40 can be implemented by a blower, an air pump, and a compressor. Herein, the oxidizer includes pure oxygen, air, etc. The oxidizer supplier 40 may also perform the function of an oxidizer supply controlling apparatus which supplies oxidizer to a heater 20 for rapidly preheating the main body 10 of the fuel cell when the fuel cell is started, and which blocks oxidizer supplied to the heater 20 when the main body 10 of the fuel cell is normally operated.

The fuel supplier 50 is an apparatus for supplying fuel to the anode side of the fuel cell 10 and the heater 20. A tube connecting the fuel supplier 50 to the fuel inlet (not shown) of the heater 20 is provided with a first valve 51 for controlling fuel flow, and the tube connecting the fuel supplier 50 to the fuel inlet (not shown) of the anode side of the main body 10 of the fuel cell is provided with a second valve 52 for controlling fuel flow. Herein, the fuel contains hydrogen supplied to the anode of the fuel cell, for example, methanol, ethanol, alcohol, city gas, natural gas, methane, and butane, etc. The first valve 51 is one example of the fuel supply controlling apparatus for controlling the fuel flow supplied to the heater 20.

In the fuel cell stack according to the present embodiment, the fuel supplier 50 supplying fuel to the main body 10 of the fuel cell uses the fuel supplier supplying fuel to the heater 20. Therefore, since the present invention uses pre-mounted fuel when the fuel cell stack is started, it does not need the further supply of fuel so that the fuel cell system can be simplified. Furthermore, when the fuel cell stack is started, the main body 10 of the fuel cell and the heater 20 are supplied with fuel by opening both the first valve 51 and the second valve 52, and after preheating the main body 10 of the fuel cell with heat generated from the heater 20, the main body of the fuel cell can be normally operated in the range of an operating temperature rapidly by a simple operation, such as the blocking of the fuel supply by closing the first valve 51.

The use of butane as a fuel in the fuel cell stack of the present invention was tested. In the test, the starting time required for raising the temperature of the fuel cell stack to the operating temperature, i.e., 200° C., was confirmed. As the result of the test, the power consumed for supplying fuel to the heater 20 and the starting time of the fuel cell stack are indicated by Table as follows.

TABLE 1

| Condition | Power Consumption | | Starting Time |
|---|---|---|---|
| No. | (W) | Fuel Type | (Sec) |
| 1 | 20 | butane | 1200 |
| 2 | 30 | butane | 586 |
| 3 | 40 | butane | 472 |
| 4 | 50 | butane | 108 |
| 5 | 60 | butane | 58 |

As indicated in Table 1, according to the present invention, it is possible to preheat the fuel cell stack up to a desired temperature, i.e. an operating temperature, with an initial power for several minutes.

Furthermore, in the fuel cell stack of the present invention, it is possible to easily control the preheating temperature of the fuel cell stack by controlling the mole ratio or stoichiometry ratio of fuel amount and air amount supplied to the heater 20. That is, the temperature condition of a normal state can be easily controlled. The test result is as shown in Table 2 as follows.

TABLE 2

| Condition | Fuel:Air (Mole | Normal State Temperature |
|---|---|---|
| No. | Ratio) | (° C.) |
| 1 | 1:32 | 250 |
| 2 | 1:35 | 235 |
| 3 | 1:40 | 203 |
| 4 | 1:42 | 180 |

It can be seen in Table 2 that the temperature condition of a normal state of the fuel cell stack, depending on the ratio of fuel to air, can be changed.

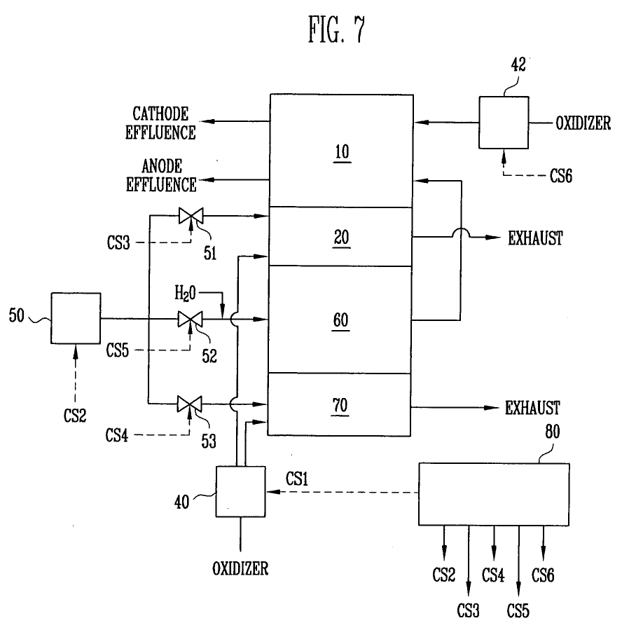

FIG. 6 is a schematically exploded perspective view of a main body of a fuel cell which can be incorporated in an embodiment of the present invention.

Referring to FIG. 6, the main body 10 of the fuel cell stack of the present invention includes a plurality of single cells. Each single cell includes a polymer electrolyte membrane 1, and an anode electrode 2 and a cathode electrode 3 bonded to both sides of the electrolyte membrane 1. The basic structure of the single cell, including the electrolyte membrane 1, the anode electrode 2, and the cathode electrode 3, is referred to as a membrane-electrode assembly. Preferably, the anode electrode 2 and the cathode electrode 3 include metal catalyst layers 2a and 3a, respectively, and diffusion layers 2b and 3b, respectively, in order to improve characteristics such as electrochemical reaction property, ion conducting property, electron conducting property, fuel transferring property, byproduct transferring property, interface stability, etc.

The main body of the fuel cell body 10 includes a first plate 5a having a flow field a1 installed thereon for supplying fuel to the anode electrode 2, and a second plate 5b having a flow field a2 installed thereon for supplying oxidizer to the cathode electrode 3. The first plate 5a and the second plate 5b can be fabricated as one bipolar plate 5 having the flow fields a1 and a2 installed on both sides thereof. The first plate 5a, the second plate 5b, and the bipolar plate 5 act as a path for electricity flow by being contacted with the anode electrode 2 or the cathode electrode 3.

Furthermore, the main body 10 of the fuel cell is stacked with a single cell, the bipolar plate 5, and another single cell, and includes a pair of end plates 6a and 6b for supporting a stack structure having the first plate 5a and the second plate 5b coupled to both ends thereof at a predetermined pressure. A pair of the end plates 6a and 6b is fixed and supported by a joint means at a predetermined pressure. In addition, a gasket 4 is installed between the electrolyte membrane 1, the first plate 5a, the second plate 5b or the bipolar plate 5 in order to prevent leakage of fuel or oxidizer.

Preferably, the main body 10 of the fuel cell includes a fuel cell for high temperature. Preferably, the electrolyte membrane 1 of the fuel cell for high temperature includes acid doped polybenzimidazole having a reaction temperature of about 150 to 200° C. as a main component. Meanwhile, the electrolyte membrane 1 as described above may include at least one selected from a group consisting of alkylsulfonationpolybenzimidazole, alkylphosphonationpolybenzimidazole, acrylmonomer polymer containing phosphoric acid, polybenzimidazole/strong acid composite, basic polymer/acidic polymer composite, and derivatives thereof. On the other hand, the electrolyte membrane 1 may include a sulfonationpolyphenylene derivative which introduces sulphonic into engineering plastic or sulfonationpolyetheretherketone as main components, or at least one of a proton conductive electrolyte membrane including nano hole, an organic-inorganic proton conductive electrolyte membrane, nafion-zirconium phosphate electrolyte membrane, and an electrolyte membrane reinforced with phosphoric acid doped nafion 117 and apatite.

The operating principle of the main body of the fuel cell as described above is as follows. If the fuel, i.e. reformed gas, is supplied to the anode electrode 2 and oxidizer is supplied to the cathode electrode 3, hydrogen proton generated from the metal catalyst layer 2a of the anode side moves to the cathode electrode 3 through the polymer electrolyte membrane 1, and water is generated by reacting hydrogen proton and oxygen with electrons in the metal catalyst layer 2a of the anode side. On the other hand, the electrons generated in the metal catalyst layer 2a of the anode side move to the cathode electrode 3 through an external circuit so that variations of free energy obtained through chemical reaction are transformed into electric energy. The whole reaction equation is represented by Reaction Equation 1 as follows.

Anode: H₂(g)->2H⁺+2e⁻

Cathode: ½O₂(g)+2H⁺+2e⁻->H₂0(1)

Whole: H₂(g)+½O₂(g)->H₂0(1) Reaction Equation 1

The pressure between anode electrode 2 and cathode electrode 3 of the main body 10 of the fuel cell may be up to 8 atmospheric pressures at normal pressure. In general, the pressures on both sides of the electrolyte membrane 1 are maintained to be identical in order to suppress crossover of fuel.

The structure of the main body 10 of the fuel cell of the present embodiment can be applied to the polymer electrolyte fuel cell, including a nafion electrolyte membrane requiring humidification, as well as to a fuel cell for high temperature including a phosphoric acid impregnated electrolyte membrane.

FIG. 7 is a schematic view of a fuel cell using a fuel cell stack according to an embodiment of the present invention.

Referring to FIG. 7, a fuel cell of the present invention includes a main body 10 of a fuel cell for generating electric energy by electro-chemical reaction between fuel and oxidizer, a heater 20 for supplying heat for preheating the main body 10 of the fuel cell when starting, a first oxidizer supplier 40 for supplying oxidizer to the heater 20, a second oxidizer supplier 42 for supplying oxidizer to the main body 10 of the fuel cell, a fuel supplier 50 for supplying fuel to the main body 10 of the fuel cell, the heater 20, and a heat source 70, a reformer 60 for generating hydrogen rich refomate by reforming fuel supplied from the fuel supplier 50 into steam, and for supplying the generated refomate as fuel in another form to the main body 10 of the fuel cell, a heat source 70 for supplying heat required for a reforming catalyst reaction of the reformer 60, and a controller 80 for controlling fuel amount supplied from the fuel supplier 50 to the heater 20, the reformer 60, and the heat source 70, and for controlling the first and second oxidizer suppliers and 42, respectively.

The fuel supplier 50 may be implemented by a fuel tank for storing fuel and a fuel pump for exhausting the fuel stored in the fuel tank at a predetermined pressure. In this case, it is preferable that the fuel pump be controlled by the controller 80. Also, the fuel supplier 50 may be implemented by a tank bearable against a predetermined positive pressure, such as a butane can and liquid butane fuel stored in the tank. In this case, the fuel pump may be omitted in the fuel supplier 50.

A first valve 51 is installed between the fuel supplier 50 and the heater 20, a second valve 52 is installed between the fuel supplier 50 and the reformer 60, and a third valve 53 is installed between the fuel supplier 50 and the heat source 70. Opening is controlled by the controller 80. The first valve 51 is opened when the fuel cell is started, and is closed when the fuel cell is normally operated and the operation thereof is stopped. The second valve 52 and the third valve 53 are opened when the fuel cell is started and normally operated, and are closed when the operation of the fuel cell is stopped.

The first oxidizer supplier 40 is installed so as to supply oxidizer to the heater 20 and the heat source 70 as a single apparatus, and is controlled by the controller 80. The first oxidizer supplier 40 may be implemented so as to supply oxidizer to the heater 20 and the heat source 70 when the fuel cell is started, to supply oxidizer to only the heat source 70 when the fuel cell is normally operated, and not to supply oxidizer to the heater 20 and the heat source 70 when the operation of the fuel cell is stopped.

The fuel cell according to the present embodiment is constituted by the main body 10 of the fuel cell to which the fuel cell stack is attached, and the heater attached to one side of the main body 10 of the fuel cell for rapidly preheating the fuel cell stack when the fuel cell is started, wherein the heater 20 includes an oxidation catalyst.

Since the heater 20 using the oxidation catalyst hardly needs any additional apparatuses excepting the fuel supplier, it is very easy to simplify the system. In addition, since the supply of fuel to the heater 20 can be accomplished using a pre-mounted fuel supplier 50, this can also contribute to simplification of the system.

In particular, when supplying fuel to the heater 20, the main body 10 of the fuel cell, and the heat source 70 using the single fuel supplier 50, the supply of fuel can be simply realized by controlling the first, second and third valves 51, 52, and 53, respectively.

Furthermore, the fuel cell according to the present embodiment can supply heat generated by the heater 20 when the fuel cell is started by attaching the reformer 60 to another side of the heater 20 attached to one side of the main body 10 of the fuel cell for preheating when the main body 10 of the fuel cell is started. Therefore, according to the present embodiment, it can improve system efficiency by increasing heat utilization.

As described above, according to the present invention, it is possible to rapidly raise the temperature of the fuel cell stack to an operating temperature when the fuel cell stack is started, and to easily control the temperature of the external heater for heating the main body of the fuel cell by controlling the ratio of fuel to air supplied to the heater. Therefore, it has the advantages of reducing the starting time of the fuel cell stack and reducing the power consumed when the fuel cell stack is started. Furthermore, it is possible to provide an excellent fuel cell with a short starting time and to improve user convenience of the fuel cell.

Although a few embodiments of the present invention have been shown and described, it will be appreciated by those skilled in the art that changes can be made in this embodiment without departing from the principles and spirit of the invention, the scope of which is defined in the claims and their equivalents.

What is claimed is:

1. A fuel cell stack, comprising:
a main body of a fuel cell having an electrolyte membrane, and an anode electrode and a cathode electrode bonded to both sides of the electrolyte membrane for generating electric energy by electrochemical reaction between fuel supplied to the anode electrode and oxidizer supplied to the cathode electrode; and
a heater having a chamber attached to the main body of the fuel cell and an oxidation catalyst installed inside the chamber, wherein the heater generates heat by oxidizing fuel supplied to an interior of the chamber when the main body of the fuel cell is started, and the heater heats the main body of the fuel cell with the generated heat.

2. The fuel cell stack as claimed in claim 1, further comprising heat conductive adhesion means for attaching the heater to an exterior of the main body of the fuel cell.

3. The fuel cell stack as claimed in claim 2, wherein the chamber and the main body of the fuel cell each include a relief structure at a portion where the chamber and the main body contact each other.

4. The fuel cell stack as claimed in claim 1, wherein the chamber and the main body of the fuel cell each include a relief structure at a portion where the chamber and the main body contact each other.

5. The fuel cell stack as claimed in claim 1, further including a supporting member for closely adhering the chamber and the main body of the fuel cell.

6. The fuel cell stack as claimed in claim 1, wherein the heater includes two heaters installed on at least both opposite sides of the main body of the fuel cell.

7. The fuel cell stack as claimed in claim 1, further comprising an oxidizer supplier for supplying oxidizer to the heater.

8. The fuel cell stack as claimed in claim 7, further comprising an oxidizer supplying controller for blocking the oxidizer supplied by the oxidizer supplier to the heater.

9. The fuel cell stack as claimed in claim 7, wherein a temperature of the main body of the fuel cell is controlled depending on an allocation ratio of the fuel and the oxidizer supplied to the main body of the fuel cell.

10. The fuel cell stack as claimed in claim 1, wherein the heater includes an outlet for exhausting byproducts generated by an oxidation catalyst reaction.

11. The fuel cell stack as claimed in claim 1, wherein the electrolyte membrane includes acid doped poly polybenzimidazole as a main component.

12. The fuel cell stack as claimed in claim 1, wherein the electrolyte membrane includes at least one of alkylsulfonationpolybenzimidazole, alkylphosphonationpolybenzimidazole, acrylmonomer polymer containing phosphoric acid, polybenzimidazole/strong acid composite, basic polymer/acidic polymer composite, and derivatives thereof.

13. The fuel cell stack as claimed in claim 1, wherein the electrolyte membrane includes one of sulfonationpolyphenylene derivative, which introduces sulphonic into engineering plastic, and sulfonationpolyetheretherketone as main components.

14. The fuel cell stack as claimed in claim 1, wherein the electrolyte membrane includes at least one of a proton conductive electrolyte membrane including nano hole, an organic-inorganic proton conductive electrolyte membrane, nafion-zirconium phosphate electrolyte membrane, and an electrolyte membrane reinforced with phosphoric acid doped nafion 117 and apatite.

15. A fuel cell, comprising:
a main body of a fuel cell having an electrolyte membrane, and an anode electrode and a cathode electrode bonded to both sides of the electrolyte membrane for generating electric energy by electro-chemically reacting fuel supplied to the anode electrode and oxidizer supplied to the cathode electrode;
a heater having a chamber attached to at least one side of the main body of the fuel cell and an oxidation catalyst installed inside the chamber, wherein the heater generates heat by oxidizing fuel supplied to an interior of the chamber when the main body of the fuel cell is started and heats the main body of the fuel cell with the generated heat; and
a fuel supplier for supplying fuel to the main body of the fuel cell and the heater.

16. The fuel cell as claimed in claim 15, further comprising heat conductive adhesion means for attaching the heater to the outside of the main body of the fuel cell.

17. The fuel cell as claimed in claim 16, wherein the chamber and the main body of the fuel cell each include a relief structure at a portion where the chamber and the main body contact each other.

18. The fuel cell as claimed in claim 16, wherein the heater includes two heaters installed on at least both opposite sides of the main body of the fuel cell.

19. The fuel cell as claimed in claim 16, further including an oxidizer supplier for supplying oxidizer to the heater.

20. The fuel cell as claimed in claim 19, further comprising an oxidizer supplying controller for blocking the oxidizer supplied by the oxidizer supplier to the heater.

21. The fuel cell as claimed in claim 19, further comprising a controller for controlling flow rate of the fuel supplied to the heater and flow rate of the oxidizer supplied to the heater, wherein a temperature of the main body of the fuel cell is controlled according to an allocation ratio of the fuel and the oxidizer supplied to the main body of the fuel cell.

22. The fuel cell as claimed in claim 19, further comprising another oxidizer supplier for supplying the oxidizer to the main body of the fuel cell.

23. The fuel cell as claimed in claim 15, wherein the chamber and the main body of the fuel cell each include a relief structure at a portion where the chamber and the main body contact each other.

24. The fuel cell as claimed in claim 15, further comprising a supporting member for closely adhering the heater and the main body of the fuel cell.

25. The fuel cell as claimed in claim 15, wherein the main body of the fuel cell includes a phosphoric acid single cell in which the electrolyte membrane uses acid doped polybenzimidazole as a main component.

26. A fuel cell operating method for supplying heat to a main body of a fuel cell so as to rapidly preheat the main body of the fuel cell, the fuel cell having an electrolyte membrane and an anode electrode and a cathode electrode bonded to both sides of the electrolyte membrane, said method comprising the steps of:
supplying fuel and oxidizer to a chamber attached to the main body of the fuel cell and a heater having an oxidization catalyst installed inside the chamber; and
heating the main body of the fuel cell up to a desired temperature with heat generated by the heater.

27. The fuel cell operating method as claimed in claim 26, further comprising the step of controlling an allocation ratio of the fuel and the oxidizer supplied to the main body of the fuel cell in order to heat the main body of the fuel cell to a desired temperature.

28. The fuel cell operating method as claimed in claim 26, further comprising the step of blocking the fuel and the oxidizer supplied to the heater through a fuel supplying controller and an oxidizer supplying controller when the temperature of the main body of the fuel cell reaches a desired temperature.

29. The fuel cell operating method as claimed in claim 28, further comprising the step of supplying fuel to the anode electrode of the main body of the fuel cell body and oxidizer to the cathode electrode of the main body of the fuel cell.
